(19) United States
(12) Patent Application Publication
(10) Pub. No.: US 2025/0310990 A1
(43) Pub. Date: Oct. 2, 2025

(54) PERIODIC CHANNEL ACCESS

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Bilal Sadiq, Plano, TX (US)

(21) Appl. No.: 19/087,883

(22) Filed: Mar. 24, 2025

Related U.S. Application Data
(60) Provisional application No. 63/573,297, filed on Apr. 2, 2024.

(51) Int. Cl. H04W 74/04; H04W 74/0816

(52) U.S. Cl. CPC H04W 74/04; H04W 74/0816

(57) ABSTRACT

An access point (AP) for facilitating communication in a wireless network. The AP has a memory and a processor coupled to the memory. The AP transmits, to one or more stations (STAs), an announcement frame indicating a schedule during which a non-primary channel access mode is enabled, wherein the non-primary channel access mode allows the one or more STAs to transmit on an idle secondary channel when a primary channel is busy. The AP performs transmissions with at least one STA on the idle secondary channel when the primary channel is busy.

### CROSS REFERENCE TO RELATED APPLICATION

This application claims benefit of U.S. Provisional Application No. 63/573,297, entitled “PERIODIC CHANNEL ACCESS,” filed on Apr. 2, 2024, which is incorporated herein by reference in its entirety.

### TECHNICAL FIELD

This disclosure relates generally to a wireless communication system, and more particularly to, for example, but not limited to, channel access in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and procedure for providing non-primary channel access.

An aspect of this disclosure provides an access point (AP) for facilitating communication in a wireless network. The AP comprises a memory and a processor coupled to the memory. The processor is configured to cause transmitting, to one or more stations (STAs), an announcement frame indicating a schedule during which a non-primary channel access mode is enabled. The non-primary channel access mode allows the one or more STAs to transmit one or more frames on an idle secondary channel when a primary channel is busy. The processor is further configured to cause performing communication with at least one STA on the idle secondary channel when the primary channel is busy.

In an embodiment, the schedule includes one or more service periods in a periodic manner.

In an embodiment, the announcement frame includes periodicity information for the one or more service periods.

In an embodiment, the schedule indicates that the non-primary channel access mode is temporarily disabled for one or more service periods.

In an embodiment, the one or more service periods are target wake time (TWT) service periods.

In an embodiment, the one or more service periods are restricted TWT service periods.

In an embodiment, the announcement frame indicates that a first set of STAs are assigned to a first schedule and a second set of STAs are assigned to a second schedule.

In an embodiment, the processor is further configured to cause receiving, from a STA, a request frame requesting that the non-primary channel access mode is enabled. The processor is further configured to cause transmitting, to the one or more STAs, the announcement frame in response to the request frame.

An aspect of the disclosure provides a STA for facilitating communication in a wireless network. The STA comprises a memory and a processor coupled to the memory. The processor is configured to cause receiving, from an AP, an announcement frame indicating a schedule during which a non-primary channel access mode is enabled. The non-primary channel access mode allows the STA to transmit one or more frames on an idle secondary channel when a primary channel is busy. The processor is further configured to cause performing communication on the idle secondary channel when the primary channel is busy.

In an embodiment, the schedule includes one or more service periods in a periodic manner.

In an embodiment, the announcement frame includes periodicity information for the one or more service periods.

In an embodiment, the schedule indicates that the non-primary channel access mode is temporarily disabled for one or more service periods.

In an embodiment, the one or more service periods are TWT service periods.

In an embodiment, the one or more service periods are restricted TWT service periods.

In an embodiment, the announcement frame indicates that a first set of STAs are assigned to a first schedule and a second set of STAs are assigned to a second schedule. The STA is assigned to either the first schedule or the second schedule.

In an embodiment, the processor is further configured to cause transmitting, to the AP, a request frame requesting that the non-primary channel access mode is enabled. The processor is further configured to cause receiving, from the AP, the announcement frame in response to the request frame.

An aspect of the disclosure provides a method performed by an AP. The method comprises transmitting, to one or more STAs, an announcement frame indicating a schedule during which a non-primary channel access mode is enabled. The non-primary channel access mode allows the one or more STAs to transmit one or more frames on an idle secondary channel when a primary channel is busy. The method further comprises performing communication with at least one STA on the idle secondary channel when the primary channel is busy.

In an embodiment, the schedule includes one or more service periods in a periodic manner.

In an embodiment, the announcement frame indicates that a first set of STAs are assigned to a first schedule and a second set of STAs are assigned to a second schedule.

In an embodiment, the method further comprises receiving, from a STA, a request frame requesting that the non-primary channel access mode is enabled. The method further comprises transmitting, to the one or more STAs, the announcement frame in response to the request frame.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example bandwidth of a channel in accordance with an embodiment.

FIG. 5 shows another example bandwidth of a channel in accordance with an embodiment.

FIG. 6 shows an example schedule in accordance with an embodiment.

FIG. 7 shows another example schedule in accordance with an embodiment.

FIG. 8 shows another example schedule in accordance with an embodiment.

FIG. 9 shows another example schedule in accordance with an embodiment.

FIG. 10 shows another example schedule in accordance with an embodiment.

FIG. 11 shows another example schedule in accordance with an embodiment.

FIG. 12 shows another example bandwidth of a channel in accordance with an embodiment.

FIG. 13 shows another example bandwidth of a channel in accordance with an embodiment.

FIG. 14 shows an example process establishing a schedule in accordance with an embodiment.

FIG. 15 shows another example process establishing a schedule in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address tie issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

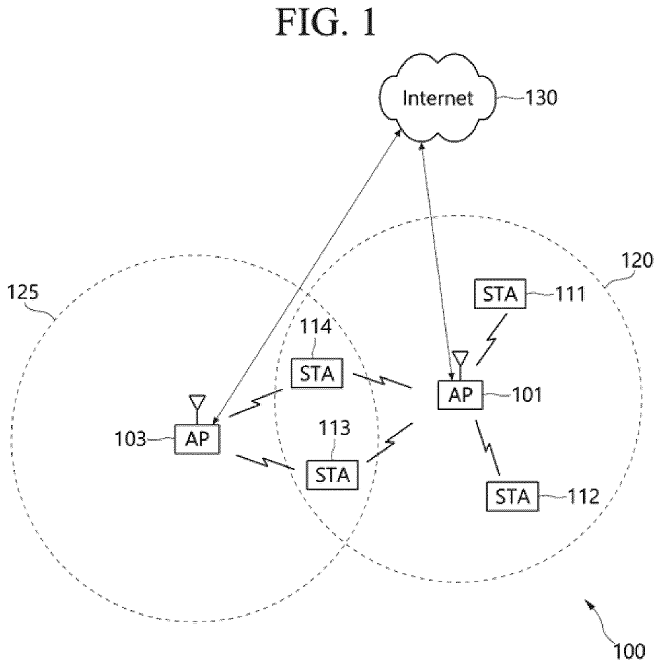

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

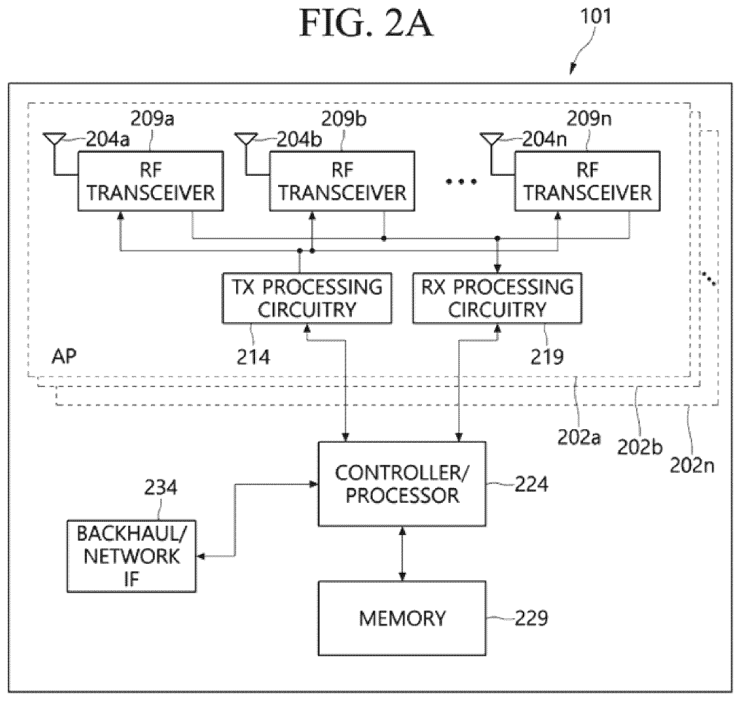

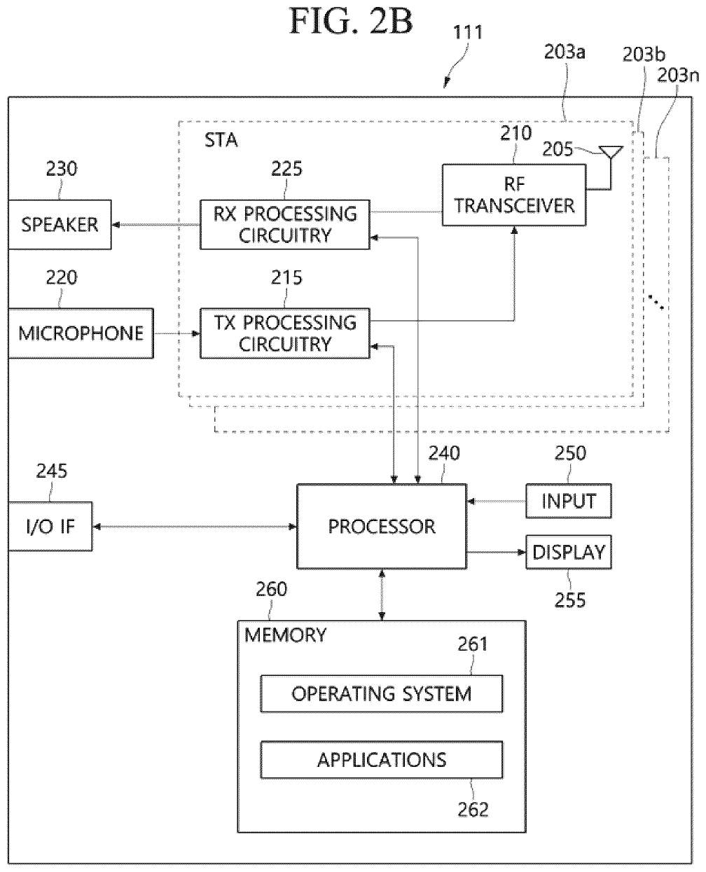

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP multi-link device (MLD) that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

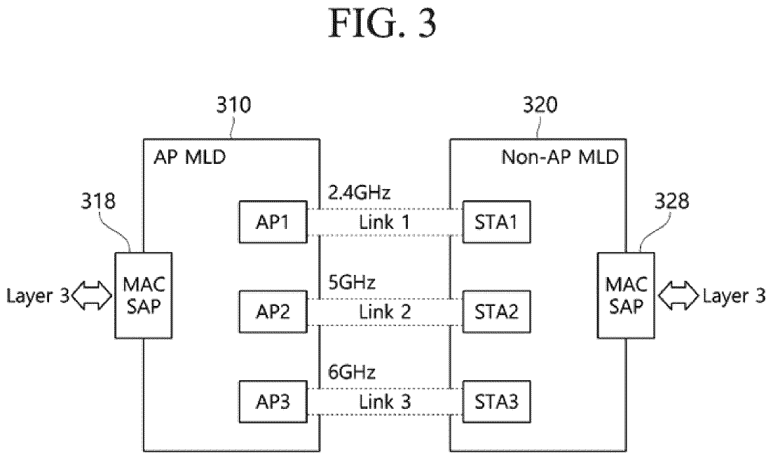

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Part 11: Wireless LAN Medium Access Control (MAC) and Physical Layer (PHY) Specifications—Amendment 8: Enhancements for extremely high throughput (EHT).”

Target wake time (TWT) is one of the most important features for power management in Wi-Fi networks, which was developed by IEEE 802.11ah and later adopted and modified into IEEE 802.11ax. TWT allows an AP to manage activity in the BSS to minimize contention between STAs and reduce the required amount of time that a STA utilizing a power management mode needs to be awake. This is achieved by allocating STAs to operate at non-overlapping times and/or frequencies and concentrating the frame exchange sequences in predefined service periods. With TWT operation, it suffices for an STA to only wake up at a pre-scheduled time negotiated with another STA or AP in the network. A STA does not need to be aware of the values of TWT parameters of the TWT agreements of other STAs in the BSS of the STA or of TWT agreements of STAs in other BSSs. A STA does not need to be aware that a TWT service period (SP) is used to exchange frames with other STAs. Frames transmitted during a TWT SP are carried in any PPDU format supported by the pair of STAs that have established the TWT agreement corresponding to that TWT SP, including high efficiency (HE) multi-user (MU) physical layer (PHY) protocol data unit (PPDU), HE trigger-based (TB) PPDU, etc.

In IEEE 802.11 standards, two types of TWT operation are possible-individual TWT operation and broadcast TWT operation. Individual TWT agreements can be established between two STAs or between an STA and an AP. The negotiation that takes place for an individual TWT agreement between two STAs is on an individual basis. The AP can have TWT agreements with multiple STAs. Any changes in the TWT agreement between the AP and one STA do not affect the TWT agreement between the AP and the other STA.

IEEE 802.11ax first introduced the broadcast TWT operation. The broadcast TWT operates in a membership-based approach. With broadcast TWT operation, an AP can set up a shared TWT session for a group of STAs. The AP is typically the controller of the broadcast TWT schedule. The non-AP STAs in the BSS can request membership in the schedule or the AP can send an unsolicited response to the STA to make the STA a member of the broadcast TWT schedule the AP maintains in the BSS. The AP can advertise/announce and maintain multiple broadcast TWT schedules in the network. When a change is made to any of the schedules in the network, it affects all the STAs that are members of that particular schedule.

Multi-link operation (MLO) is another key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD. TWT enhancements for multi-link devices have recently been introduced in IEEE 802.11be specification. For individual TWT agreements between two MLDs, a STA affiliated with an MLD, which is a TWT requesting STA, may indicate the link(s) that are requested for setting up TWT agreement(s) in the Link ID Bitmap subfield, if present, of a TWT element in the TWT request. If only one link is indicated in the Link ID Bitmap subfield of the TWT element, then a single TWT agreement is requested for the STA affiliated with the same MLD, which is operating on the indicated link. The Target Wake Time field of the TWT element shall be in reference to the timing synchronization function (TSF) time of the link indicated by the TWT element. A TWT responding STA affiliated with a peer MLD that receives a TWT request that contains a Link ID Bitmap subfield in a TWT element shall respond with a TWT response that indicates the link(s) in the Link ID Bitmap field of a TWT element. The link(s), if present, in the TWT element carried in the TWT response, shall be the same as the link(s) indicated in the TWT element of the soliciting TWT request.

Restricted TWT (R-TWT) operation is another key feature introduced in IEEE 802.11be standards with a view to providing better support for latency-sensitive applications. Restricted TWT offers a protected service period for its member STAs by sending Quiet elements to other STAs in the BSS which are not a member of the R-TWT schedule, where the Quiet interval corresponding to the Quiet element overlaps with the initial portion of the restricted TWT SP. Hence, it gives more channel access opportunities for the R-TWT member scheduled STAs, which definitely helps latency-sensitive traffic flow.

Present transmission in the wireless medium requires the primary 20 MHz channel to be idle in order to access the wider bandwidth channel (e.g., 40/80/160/320 MHz). A STA cannot transmit on an idle secondary channel when the primary channel is busy, wasting the bandwidth.

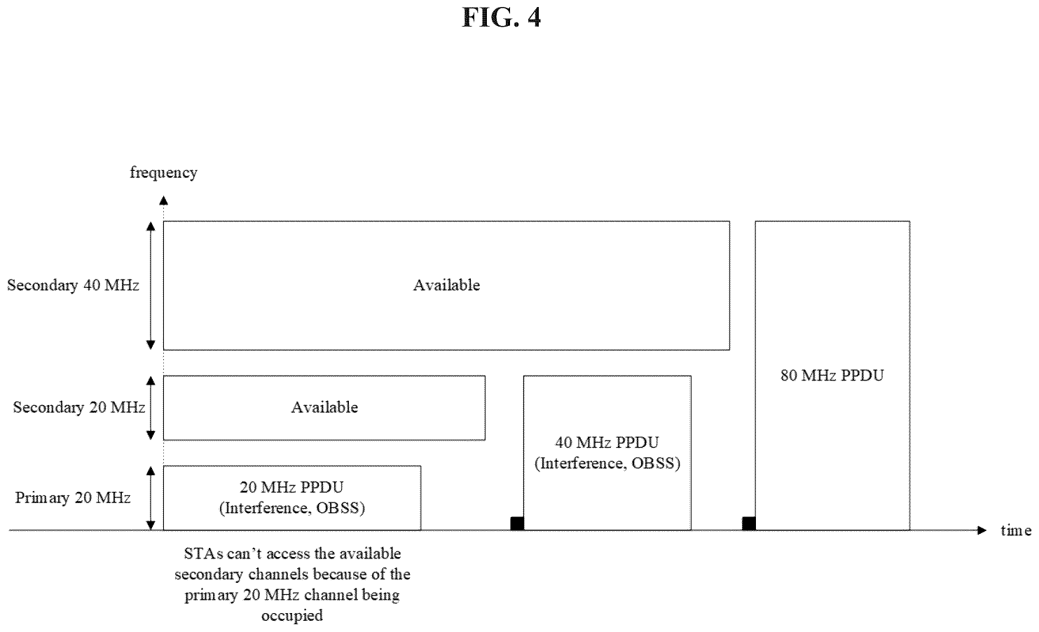

FIG. 4 shows an example bandwidth of a channel in accordance with an embodiment. The example depicted in FIG. 4 is for explanatory and illustration purposes. FIG. 4 does not limit the scope of this disclosure to any particular implementation.

Referring FIG. 4, the horizontal axis represents time. The vertical axis represents frequency. FIG. 4 shows an example 80 MHz channel that includes a primary 20 MHz channel, a secondary 20 MHz channel, and a secondary 40 MHz channel.

In this example, when the primary 20 MHz channel is occupied by a 20 MHz PPDU, either by interference or other OBSS transmission, a STA can't access the available secondary 20 MHz channel or secondary 40 MHz channel because the 20 MHz PPDU occupies the primary 20 MHz channel. Additionally, when the primary 20 MHz channel and the secondary 20 MHz channel are occupied by a 40 MHz PPDU, either by interference or other OBSS transmission, the STA can't access the available secondary 40 MHz channel because the primary 20 MHz channel is occupied. The STA may transmit an 80 MHz PPDU when all of the primary 20 MHz channel, the secondary 20 MHz channel and the secondary 40 MHz channel are available.

A non-primary channel access (NPCA) procedure is necessary to resolve this waste of bandwidth. Accordingly, an NPCA procedure is considered in the 802.11bn group discussions. A STA using NPCA can transmit in idle secondary channels when the primary channel is busy, from interference or other OBSS transmission.

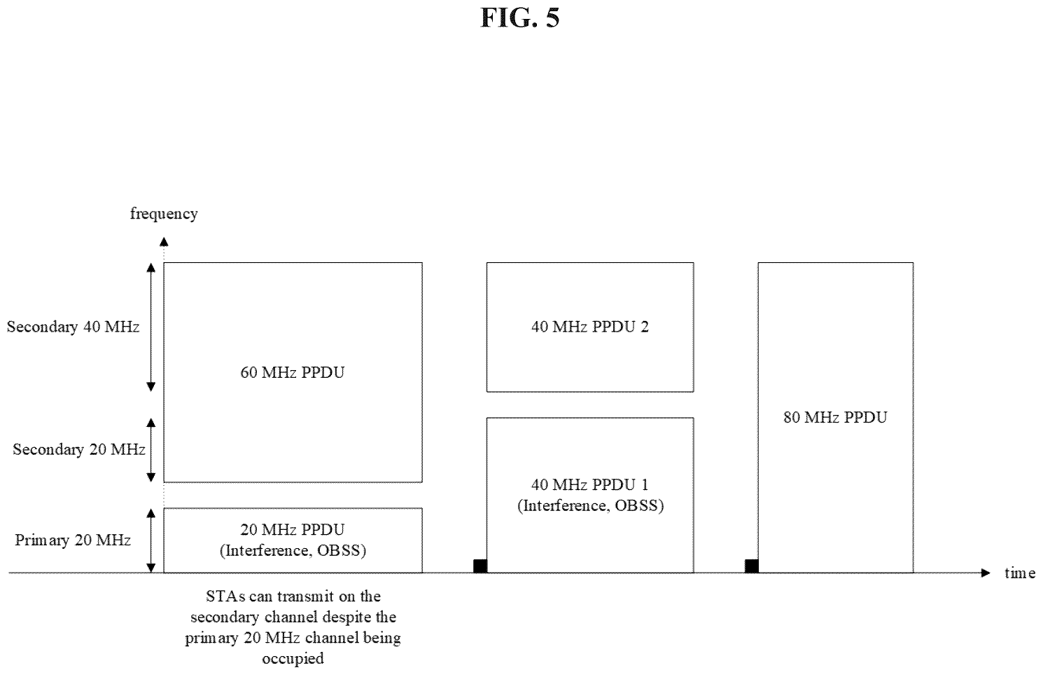

FIG. 5 shows another example bandwidth of a channel in accordance with an embodiment. The example depicted in FIG. 5 is for explanatory and illustration purposes. FIG. 5 does not limit the scope of this disclosure to any particular implementation.

Referring FIG. 5, the horizontal axis represents time. The vertical axis represents frequency. FIG. 5 shows an example 80 MHz channel that includes a primary 20 MHz channel, a secondary 20 MHz channel, and a secondary 40 MHz channel.

In this example, when the primary 20 MHz channel is occupied by a 20 MHz PPDU, either by interference or other OBSS transmission, a STA can access the available secondary 20 MHz channel and secondary 40 MHz channel to transmit a 60 MHz PPDU even though the primary 20 MHz channel is occupied. Additionally, when the primary 20 MHz channel and the secondary 20 MHz channel are occupied by a 40 MHz PPDU 1, either by interference or other OBSS transmission, the STA can access the available secondary 40 MHz channel even though the primary 20 MHz channel and secondary 20 MHz channel are occupied. The STA may transmit an 80 MHz PPDU when all of the primary 20 MHz channel, the secondary 20 MHz channel and the secondary 40 MHz channel are available.

Implementation of a NPCA procedure requires a mechanism to indicate the time when it should be enabled and the NPCA operation requires such timing information to operate efficiently. This disclosure introduces the necessary NPCA procedure and operation, including for periodic NPCA.

In an embodiment, NPCA operation can perform in a periodic manner. NPCA can be enabled during allowed time windows which may be referred to as service periods (SPs).

In an embodiment, an AP can indicate NPCA information including when the NPCA is enabled, how long the NPCA will remain enabled and the time windows during which the NPCA process is allowed. The AP can transmit an announcement frame including the NPCA information. The announcement frame may be Beacon or Probe Response frame. The NPCA information can be carried in an NPCA element. The AP can transmit a broadcast frame including the NPCA information in the NPCA element. The broadcast frame can be referred to as an NPCA Information frame.

In an embodiment, an AP or a STA can include a TWT element in the NPCA Information frame to share NPCA periodicity information. The TWT element can be used to indicate periods during which NPCA is enabled or allowed.

In an embodiment, a STA can't use NPCA outside an NPCA SP that is indicated in a TWT element or a NPCA element when receiving the NPCA element including periodicity information or TWT element that is included in the NPCA Information frame. A STA can use NPCA during a NPCA SP.

In an embodiment, an AP can indicate a series of NPCA SPs during which the NPCA operation is enabled. Outside of the NPCA SPs, the NPCA operation is disabled or not allowed. The series of NPCA SPs may be referred to as a NPCA schedule.

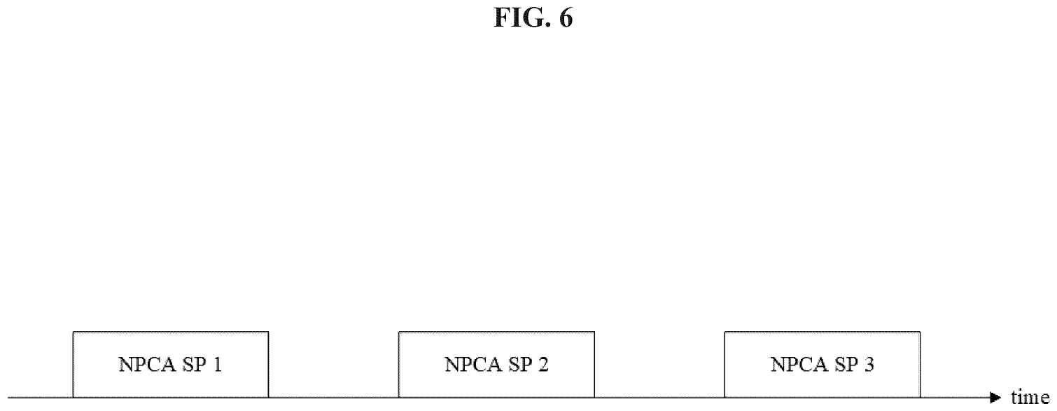

FIG. 6 shows an example schedule in accordance with an embodiment. The example depicted in FIG. 6 is for explanatory and illustration purposes. FIG. 6 does not limit the scope of this disclosure to any particular implementation.

Referring to FIG. 6, the horizontal axis represents time. An AP has set up an NPCA schedule for a transmission opportunity (TXOP), obtained by the AP, comprising a series of NPCA SPs. The NPCA schedule includes NPCA SP 1, NPCA SP 2 and NPCA SP 3. The AP grants the TXOP to a STA. The STA can use NPCA operation during NPCA SP 1, NPCA SP 2 and NPCA SP 3. The AP may transmit, to the STA, a frame indicating that NPCA is enabled for NPCA SP 1, NPCA SP 2 and NPCA SP 3.

In an embodiment, an AP can indicate which SP in a NPCA schedule is temporarily disabled for NPCA operation. Other SPs can still be available for NPCA operation.

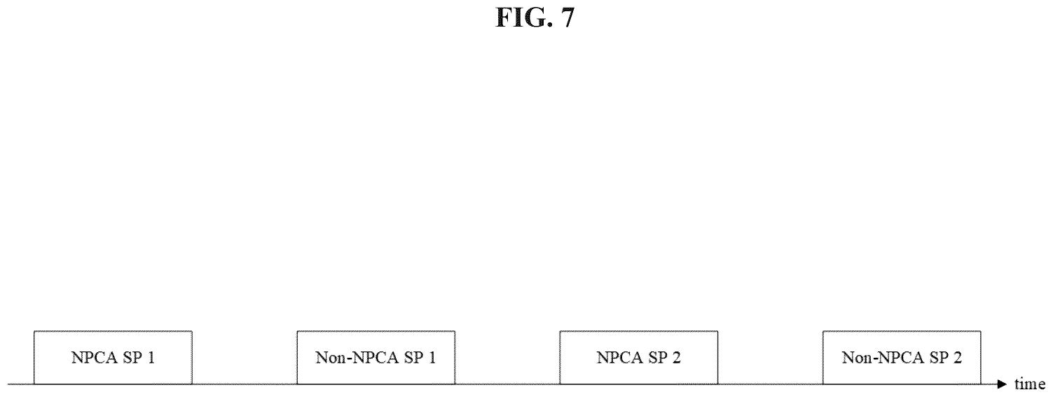

FIG. 7 shows another example schedule in accordance with an embodiment. The example depicted in FIG. 7 is for explanatory and illustration purposes. FIG. 7 does not limit the scope of this disclosure to any particular implementation.

Referring to FIG. 7, the horizontal axis represents time. An AP has set up an NPCA schedule for a TXOP, obtained by the AP, comprising a series of NPCA SPs and Non-NPCA SPs. The NPCA schedule includes NPCA SP 1, Non-NPCA SP 1, NPCA SP 2 and Non-NPCA SP 2. The AP enables NCPA operation for NPCA SP 1 and NPCA SP 2. The AP disables NPCA operation for Non-NPCA SP 1 and Non-NPCA SP 2. The AP grants the TXOP to a STA. The STA can use NPCA operation during NPCA SP 1 and NPCA SP 2. The STA cannot use NPCA operation during Non-NPCA SP 1 and Non-NPCA SP 2. The AP may transmit, to the STA, a frame indicating that NPCA is enabled for NPCA SP 1 and NPCA SP 2.

In an embodiment, an AP can establish multiple NPCA schedules in its BSS. The AP can indicate that a first set of STAs are assigned to a first NPCA schedule and a second set of STAs are assigned to a second NPCA schedule. In an embodiment, the first set of STAs may not transmit using NPCA outside of the NPCA SPs associated with the first NPCA schedule. The second set of STAs may not transmit using NPCA outside the NPCA SPs associated with the second NPCA schedule.

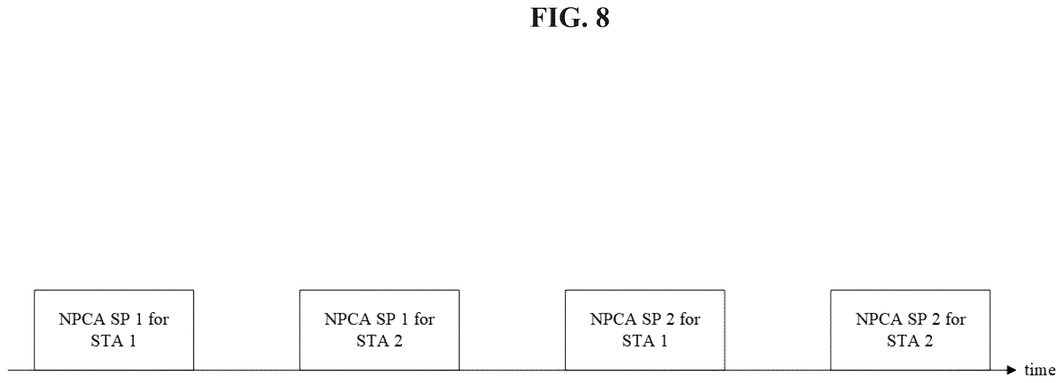

FIG. 8 shows another example schedule in accordance with an embodiment. The example depicted in FIG. 8 is for explanatory and illustration purposes. FIG. 8 does not limit the scope of this disclosure to any particular implementation.

Referring to FIG. 8, the horizontal axis represents time. An AP has set up two NPCA schedules for a TXOP, obtained by the AP, comprising a series of NPCA SPs. The AP has set up a first NPCA schedule for a STA 1. The first NPCA schedule includes NPCA SP 1 for STA 1 and NPCA SP 2 for STA 1. The AP has set up a second NPCA schedule for a STA 2. The second NPCA schedule includes NPCA SP 1 for STA 2 and NPCA SP 2 for STA 2. The AP grants STA 1 and STA 2 the TXOP. STA 1 can use NPCA operation during NPCA SP 1 for STA 1 and NPCA SP 2 for STA 1. STA 2 can use NPCA operation during NPCA SP 1 for STA 2 and NPCA SP 2 for STA 2. The AP may transmit, to STA 1, a frame indicating that NPCA is enabled for NPCA SP 1 for STA 1 and NPCA SP 2 for STA 1. The AP may transmit, to STA 2, a frame indicating that NPCA is enabled for NPCA SP 1 for STA 2 and NPCA SP 2 for STA 2.

In an embodiment, an AP can transmit an announcement frame indicating that STAs in its BSS can use a certain TWT schedule for NPCA operation. Outside the TWT SP of the TWT schedule, NPCA operation may not be allowed. The TWT SPs during which NPCA is enabled can be referred to as the NPCA-enabled TWT SP.

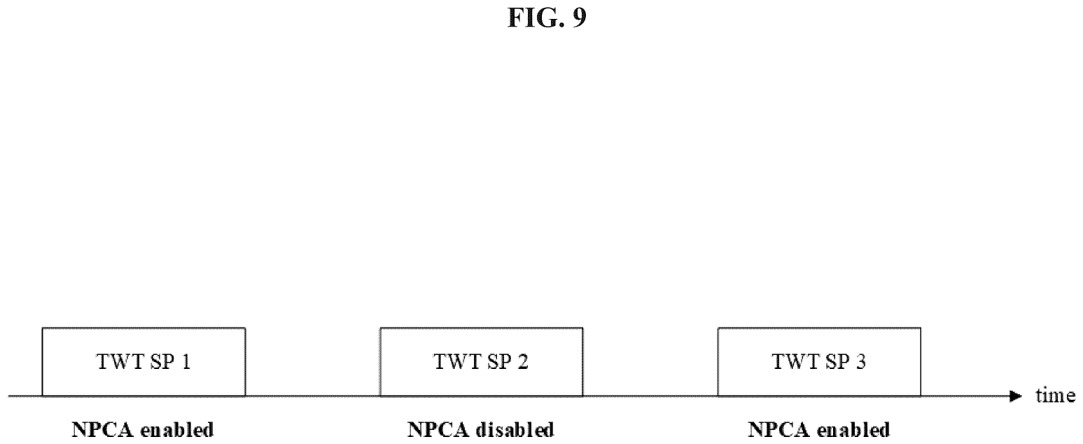

FIG. 9 shows another example schedule in accordance with an embodiment. The example depicted in FIG. 9 is for explanatory and illustration purposes. FIG. 9 does not limit the scope of this disclosure to any particular implementation.

Referring to FIG. 9, the horizontal axis represents time. An AP has set up an NPCA schedule for a TXOP, obtained by the AP, comprising a series of TWT SPs. An AP has set up the NPCA schedule for a STA. The NPCA schedule includes TWT SP 1, TWT SP 2 and TWT SP 3. The AP grants the TXOP to the STA. The AP enables NPCA operation for TWT SP 1 and TWT SP 3. The STA can use NPCA operation during TWT SP 1 and TWT SP 3. The AP does not enable NPCA operation for TWT SP 2. The STA cannot use NPCA operation. The AP may transmit, to the STA, a frame indicating that NPCA is enabled for TWT SP 1 and TWT SP 3.

In an embodiment, a STA can transmit, to an associated AP, a frame indicating that the STA requests a TWT schedule (or a TWT agreement) to be NPCA enabled. The AP can either accept or reject the request. The indicated TWT schedule (or TWT agreement) may be referred to as an NPCA enabled TWT SP if the AP accepts the request for a TWT schedule (TWT agreement).

In an embodiment, NPCA can be enabled during an R-TWT schedule. In an embodiment, STAs that are members of an NPCA enabled R-TWT schedule can use NPCA procedure to transmit frame during a R-TWT SP associated with the NPCA enabled R-TWT schedule.

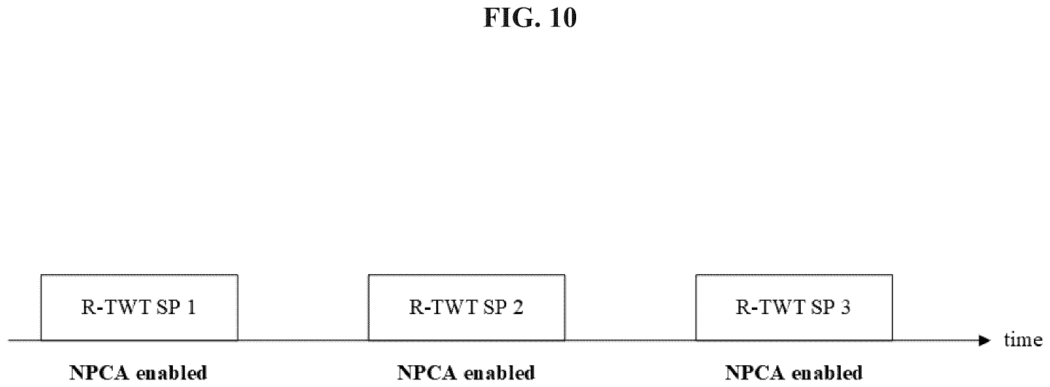

FIG. 10 shows another example schedule in accordance with an embodiment. The example depicted in FIG. 10 is for explanatory and illustration purposes. FIG. 10 does not limit the scope of this disclosure to any particular implementation.

Referring to FIG. 10, the horizontal axis represents time. An AP has set up an NPCA schedule for a TXOP, obtained by the AP, comprising a series of R-TWT SPs. An AP has set up the NPCA schedule for a STA. The NPCA schedule includes R-TWT SP 1, R-TWT SP 2 and R-TWT SP 3. The AP grants the TXOP to the STA. The AP enables NPCA operation for R-TWT SP 1, R-TWT SP 2 and R-TWT 3. The STA can use NPCA operation during R-TWT SP 1, R-TWT SP 2 and R-TWT SP 3. The AP may transmit, to the STA, a frame indicating that NPCA is enabled for R-TWT SP 1, R-TWT SP 2 and R-TWT SP 3.

In an embodiment, NPCA procedure may not be enabled during an individual TWT SPs.

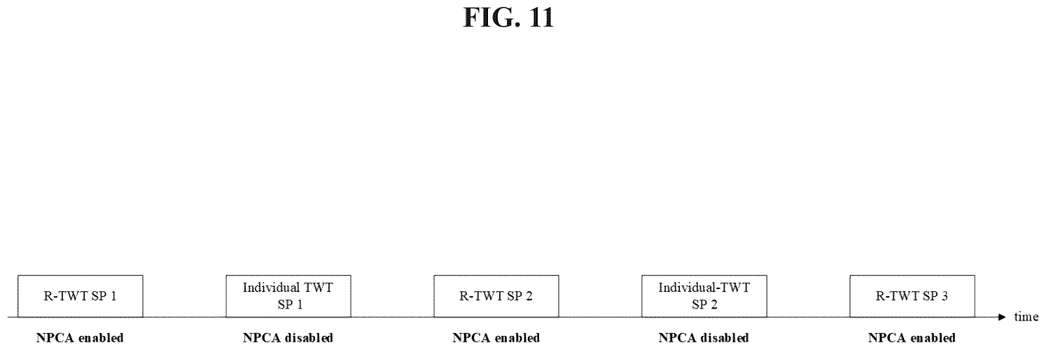

FIG. 11 shows another example schedule in accordance with an embodiment. The example depicted in FIG. 11 is for explanatory and illustration purposes. FIG. 11 does not limit the scope of this disclosure to any particular implementation.

Referring to FIG. 11, the horizontal axis represents time. An AP has set up an NPCA schedule for a TXOP, obtained by the AP, comprising a series of TWT SPs. An AP has set up the NPCA schedule for a STA. The NPCA schedule includes R-TWT SP 1, Individual TWT SP 1, R-TWT SP 2, Individual TWT 2 and R-TWT SP 3. The AP grants the TXOP to the STA. The AP enables NPCA operation for R-TWT SP 1, R-TWT SP 2 and R-TWT SP 3. The STA can use NPCA operation during R-TWT SP 1, R-TWT SP 2 and T-TWT SP 3. The STA cannot use NPCA operation during Individual TWT SP 1 and Individual TWT SP 2. The AP may transmit, to the STA, a frame indicating that NPCA is enabled for R-TWT SP 1, R-TWT SP 2 and R-TWT SP 3.

In an embodiment, all TWT SPs associated with a TWT schedule or TWT agreement may be enabled for NPCA operation. The TWT schedule or TWT agreement can be referred to as an NPCA-enabled TWT schedule or an NPCA-enabled TWT agreement, respectively. STAs and an associated AP can transmit on the secondary channel even when the primary channel is busy during the TWT SPs.

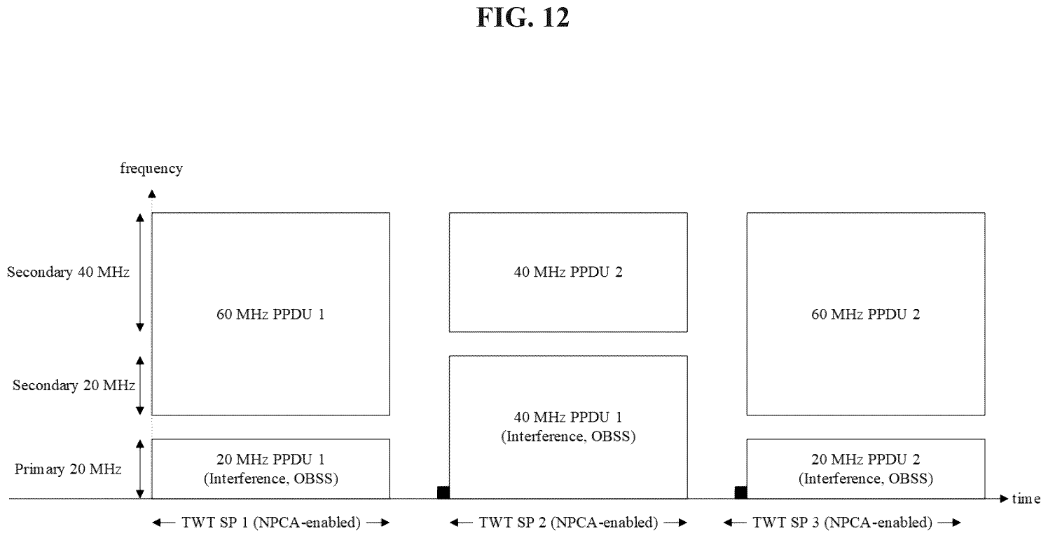

FIG. 12 shows another example bandwidth of a channel in accordance with an embodiment. The example depicted in FIG. 12 is for explanatory and illustration purposes. FIG. 12 does not limit the scope of this disclosure to any particular implementation.

Referring FIG. 12, the horizontal axis represents time. The vertical axis represents frequency. FIG. 12 shows an example 80 MHz channel that includes a primary 20 MHz channel, a secondary 20 MHz channel, and a secondary 40 MHz channel.

In this example, when the primary 20 MHz channel is occupied by a 20 MHz PPDU 1, either by interference or other OBSS transmission, a STA uses an available secondary 20 MHz channel and secondary 40 MHz channel to transmit a 60 MHz PPDU 1 even though the primary 20 MHz channel is occupied during a TWT SP 1 with NPCA enabled. Additionally, when the primary 20 MHz channel and the secondary 20 MHz channel are occupied by a 40 MHz PPDU 1, either by interference or other OBSS transmission, the STA uses the available secondary 40 MHz channel to transmit a 40 MHz PPDU 2 during a TWT SP 2 with NPCA enabled. Additionally, when the primary 20 MHz channel is occupied by a 20 MHz PPDU 2, either by interference or other OBSS transmission, the STA uses the available secondary 20 MHz channel and the secondary 40 MHz channel to transmit a 60 MHz PPDU 2 during TWT SP 3 with NPCA enabled.

In an embodiment, in an NPCA schedule or in an NPCA-enabled TWT schedule, one or more SPs can be enabled for NPCA while other SPs may be disabled for NPCA. The NPCA schedule or NPCA-enabled TWT schedule can be referred to as a mixed NPCA schedule or mixed NPCA-enabled TWT schedule. In a mixed NPCA schedule, during the disabled TWT SPs, the STAs may not access an idle secondary channel when the primary channel is busy.

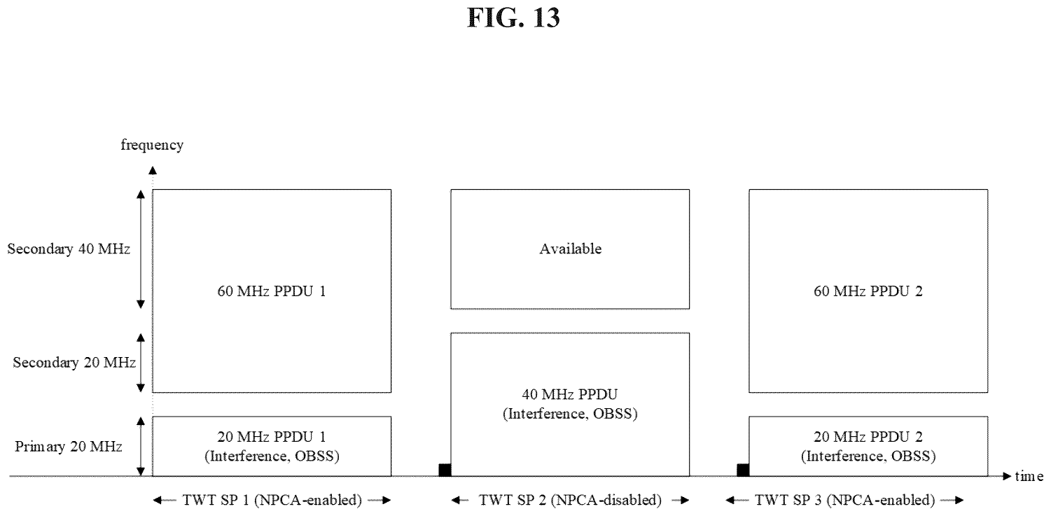

FIG. 13 shows another example bandwidth of a channel in accordance with an embodiment. The example depicted in FIG. 13 is for explanatory and illustration purposes. FIG. 13 does not limit the scope of this disclosure to any particular implementation.

Referring FIG. 13, the horizontal axis represents time. The vertical axis represents frequency. FIG. 13 shows an example 80 MHz channel that includes a primary 20 MHz channel, a secondary 20 MHz channel, and a secondary 40 MHz channel.

In this example, when a primary 20 MHz channel is occupied by a 20 MHz PPDU 1, either by interference or other OBSS transmission, a STA uses an available secondary 20 MHz channel and secondary 40 MHz channel to transmit a 60 MHz PPDU 1 even though the primary 20 MHz channel is occupied during a TWT SP 1 with NPCA enabled. Additionally, when the primary 20 MHz channel and the secondary 20 MHz channel are occupied by a 40 MHz PPDU, either by interference or other OBSS transmission, the STA cannot access the available secondary 40 MHz channel because the primary 20 MHz channel and secondary 20 MHz channel are occupied during a TWT SP 2 with NPCA disabled. Additionally, when the primary 20 MHz channel is occupied by a 20 MHz PPDU 2, either by interference or other OBSS transmission, the STA uses the available secondary 20 MHz channel and the available secondary 40 MHz channel to transmit a 60 MHz PPDU 2 during TWT SP 3 with NPCA enabled.

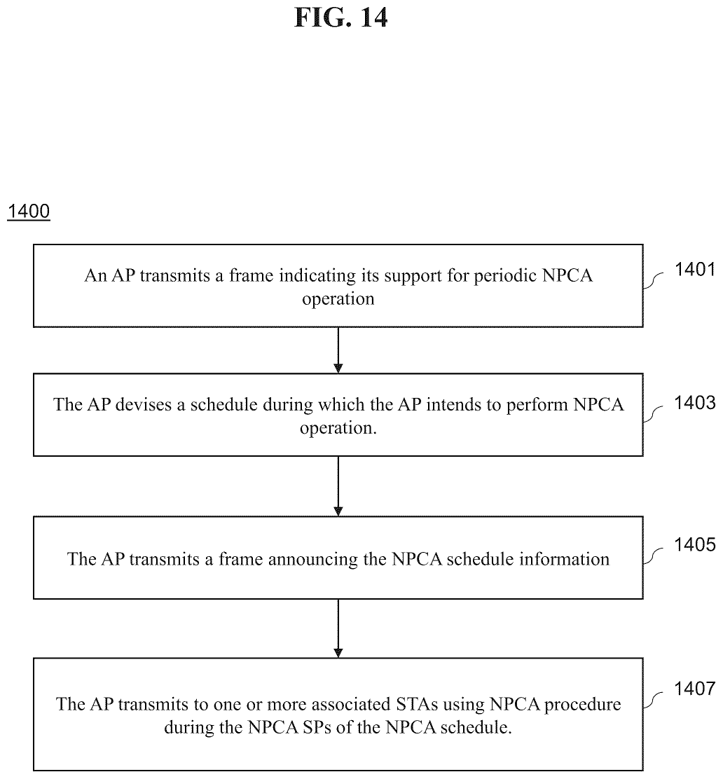

FIG. 14 shows an example process establishing a schedule in accordance with an embodiment. The process depicted in FIG. 14 is for explanatory and illustration purposes. FIG. 14 does not limit the scope of this disclosure to any particular implementation.

Referring to FIG. 14, the process 1400 begins at operation 1401. In operation 1401, an AP transmits a frame indicating its support for periodic NPCA operation. The frame may be a beacon frame, a probe response frame, an association response frame or a re-association response frame.

In operation 1403, the AP devises a schedule during which the AP intends to perform NPCA operation. The schedule may indicate a series of time windows or SPs for such NPCA operation.

In operation 1405, the AP transmits a frame announcing the NPCA schedule information. The frame may be a beacon frame, a probe response frame, an association response frame or re-association response frame.

In operation 1407, the AP transmits to one or more associated STAs using NPCA procedure during the NPCA SPs of the NPCA schedule. The AP can also receive frames from one or more STAs that have been transmitted using NPCA procedure during the NPCA SPs.

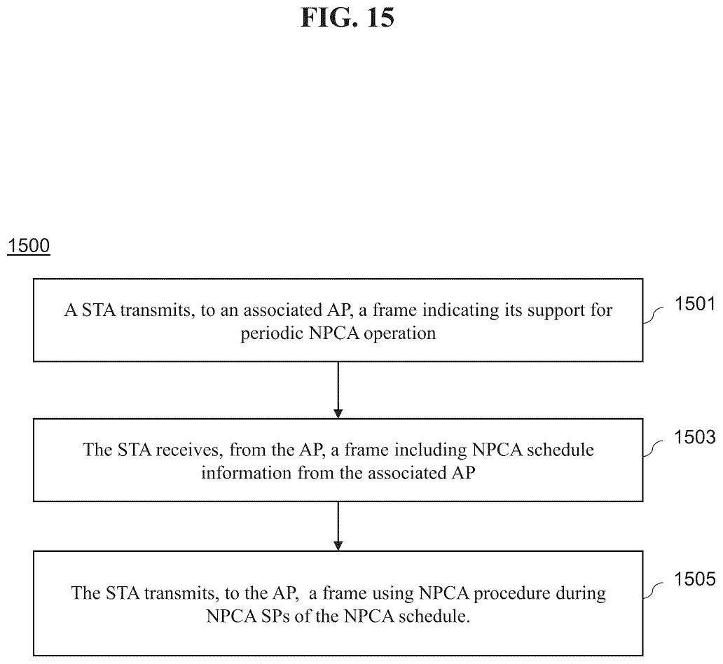

FIG. 15 shows another example process establishing a schedule in accordance with an embodiment. The process depicted in FIG. 15 is for explanatory and illustration purposes. FIG. 15 does not limit the scope of this disclosure to any particular implementation.

Referring to FIG. 15, the process 1500 begins at operation 1501. In operation 1501, a STA transmits, to an associated AP, a frame indicating its support for periodic NPCA operation. The frame may be a beacon frame, probe response frame, association response frame or re-association response frame.

In operation 1503, the STA receives, from the AP, a frame including NPCA schedule information. The NPCA schedule information can be included in a beacon frame, a probe response frame, an association response frame and a re-association response frame.

In operation 1505, the STA transmits, to the AP, a frame using NPCA procedure during NPCA SPs of the NPCA schedule. The STA can also receive frames from the AP that have been transmitted using NPCA procedure during the NPCA SPs.

The disclosure provides mechanisms and procedures for NPCA, such as providing timing information for NPCA, such as time windows or SPs, and periodic NPCA, such as NPCA schedules.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in a different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) for facilitating communication in a wireless network, comprising:
a memory;
a processor coupled to the memory, the processor configured to cause:
transmitting, to one or more stations (STAs), an announcement frame indicating a schedule during which a non-primary channel access mode is enabled, wherein the non-primary channel access mode allows the one or more STAs to transmit one or more frames on an idle secondary channel when a primary channel is busy; and
performing communication with at least one STA on the idle secondary channel when the primary channel is busy.

2. The AP of claim 1, wherein the schedule includes one or more service periods in a periodic manner.

3. The AP of claim 2, wherein the announcement frame includes periodicity information for the one or more service periods.

4. The AP of claim 2, wherein the schedule indicates that the non-primary channel access mode is temporarily disabled for one or more service periods.

5. The AP of claim 2, wherein the one or more service periods are target wake time (TWT) service periods.

6. The AP of claim 5, wherein the one or more service periods are restricted TWT service periods.

7. The AP of claim 1, wherein the announcement frame indicates that a first set of STAs are assigned to a first schedule and a second set of STAs are assigned to a second schedule.

8. The AP of claim 1, wherein the processor is further configured to cause:
receiving, from a STA, a request frame requesting that the non-primary channel access mode is enabled; and
transmitting, to the one or more STAs, the announcement frame in response to the request frame.

9. A station (STA) for facilitating communication in a wireless network, comprising:
a memory;
a processor coupled to the memory, the processor configured to cause:
receiving, from an access point (AP), an announcement frame indicating a schedule during which a non-primary channel access mode is enabled, wherein the non-primary channel access mode allows the STA to transmit one or more frames on an idle secondary channel when a primary channel is busy; and
performing communication on the idle secondary channel when the primary channel is busy.

10. The STA of claim 9, wherein the schedule includes one or more service periods in a periodic manner.

11. The STA of claim 10, wherein the announcement frame includes periodicity information for the one or more service periods.

12. The STA of claim 10, wherein the schedule indicates that the non-primary channel access mode is temporarily disabled for one or more service periods.

13. The STA of claim 10, wherein the one or more service periods are target wake time (TWT) service periods.

14. The STA of claim 13, wherein the one or more service periods are restricted TWT service periods.

15. The STA of claim 9, wherein the announcement frame indicates that a first set of STAs are assigned to a first schedule and a second set of STAs are assigned to a second schedule, wherein the STA is assigned to either the first schedule or the second schedule.

16. The STA of claim 9, wherein the processor is further configured to cause:
transmitting, to the AP, a request frame requesting that the non-primary channel access mode is enabled; and
receiving, from the AP, the announcement frame in response to the request frame.

17. A method performed by an access point (AP), the method comprising:
transmitting, to one or more stations (STAs), an announcement frame indicating a schedule during which a non-primary channel access mode is enabled, wherein the non-primary channel access mode allows the one or more STAs to transmit one or more frames on an idle secondary channel when a primary channel is busy; and
performing communication with at least one STA on the idle secondary channel when the primary channel is busy.

18. The method of claim 17, wherein the schedule includes one or more service periods in a periodic manner.

19. The method of claim 17, wherein the announcement frame indicates that a first set of STAs are assigned to a first schedule and a second set of STAs are assigned to a second schedule.

20. The method of claim 17, wherein the method further comprises:
receiving, from a STA, a request frame requesting that the non-primary channel access mode is enabled; and
transmitting, to the one or more STAs, the announcement frame in response to the request frame.
